(19) United States
(12) Patent Application Publication
(10) Pub. No.: US 2025/0163753 A1
(43) Pub. Date: May 22, 2025

(54) CORNER ASSEMBLY OF A FIXED OUTER FRAME OF A TRAPDOOR

(71) Applicant: AKIFIX S.P.A., Bolzano (IT)

(72) Inventor: Andrea MARINELLI, Bolzano (IT)

(21) Appl. No.: 18/942,960

(22) Filed: Nov. 11, 2024

(30) Foreign Application Priority Data
Nov. 17, 2023 (IT) 102023000024465

(51) Int. Cl. E06B 3/964

(52) U.S. Cl. CPC E06B 3/9641

(57) ABSTRACT

Disclosed is a corner assembly of an outer frame of a trapdoor. The corner assembly includes a corner piece, a device attached to the corner piece and screws used to fix the device to the corner piece. The corner piece has a protective partition suitable for creating a compartment that accommodates the tips of the screws and prevents the user from accidentally inserting his/her fingers inside the compartment.

### CROSS-REFERENCE TO RELATED APPLICATIONS

Not applicable.

### FIELD OF THE INVENTION

The present patent application for industrial invention relates to a corner assembly of a fixed outer frame of a trapdoor.

### BACKGROUND OF THE INVENTION

The field of reference is that of inspection trapdoors, such as the one described in the international patent application WO2022167230A1 filed in the name of the same applicant.

WO2022167230A1 specifically describes an inspection trapdoor comprising: a fixed outer frame composed of four sections connected to each other by means of four corner pieces, a movable inner frame comprising four sections connected to each other by means of four corner pieces, and a central panel supported by the movable frame.

Each one of the corner pieces comprises a main body comprising a square-shaped central portion and two lateral inserts perpendicular to each other and inserted at the ends of the sections.

Two corner pieces of the fixed frame are provided with additional devices, such as a snap-fit locking device suitable for cooperating with corresponding hooks provided on two corner pieces of the movable frame in order to firmly lock the trapdoor in closed position.

The aforementioned snap-fit locking device is mounted on a supporting wall that rises orthogonally from the body of the corner piece.

Each snap-fit locking device is attached to the corner piece by means of fixing screws that are inserted through holes provided in the attachment device and that are also inserted and engaged into holes that are suitably machined in the support wall.

The tips of the fixing screws protrude behind the support wall and are extremely dangerous for the operator in charge of holding and manipulating the corner piece.

As a matter of fact, the applicant has found out that during the installation of the trapdoor, the operators tend to hold and lift the trapdoor by using the aforementioned support walls (which support the snap-fit locking devices) as gripping and supporting points for their fingers. This is a frequent cause of injuries for the user's fingers because they may accidentally intercept or touch the tips of the aforementioned screws.

In addition, the applicant has ascertained that the corner pieces described in WO2022167230A1 are not suitable for being picked up by the industrial robotic arms used in automated processes to produce the inspection trapdoor. In fact, in order to be picked up by a robotic arm, the corner piece must be positioned on a pick-up surface in such a position as to facilitate the pick-up movement of the robotic arm, i.e. a position such that the body of the corner piece is substantially horizontal (in parallel direction to the pick-up surface).

Should the corner piece described in WO2022167230A1 be positioned on a support surface, it would always be disposed in a non-straight position, that is to say in a position such that the body of the corner piece is inclined with respect to the picking surface below. Such an inclined position does not allow a robotic arm to pick up said corner piece in order to transport it to a subsequent operating station.

### SUMMARY OF THE INVENTION

It is precisely from the careful observation of the aforementioned problems that the present invention has been devised by the applicant with the main purpose of providing the solution to said problems.

In particular, the purpose of the present invention is to provide a corner assembly comprising a corner piece and a device attached to the corner piece by means of screws that is safe and prevents the user from accidentally touching the tip of the screws and getting injured.

An additional purpose of the present invention is to provide a corner piece that can be firmly placed on a support surface with the body in parallel position relative to the support surface so as to be picked up by a robotic arm.

These purposes are achieved in accordance with the invention with the features listed in the attached independent claim 1.

Advantageous achievements appear from the dependent claims.

The corner assembly according to the invention is defined by claim 1.

### BRIEF DESCRIPTION OF DRAWINGS

For the sake of explanatory clarity, the description of the corner assembly according to the invention continues with reference to the attached drawings, which are for illustrative and non-limiting purposes only.

FIGS. 1 and 2 are axonometric views of the corner assembly according to the invention viewed from two different angles and provided with a snap-fit locking device.

FIGS. 3 and 4 are axonometric views of the corner assembly seen from two different angles devoid of the snap-fit locking device.

FIG. 5 is an axonometric view of the corner piece of the corner assembly according to the present invention resting on a support surface, wherein the support wall, the protective partitions and the partition operate as support legs for the corner piece.

FIG. 6 is a diagrammatic axonometric view of a trapdoor comprising a fixed frame provided with two corner assemblies according to the invention.

FIGS. 7 and 8 show the ways in which a user can rest his/her fingers on the corner piece without getting injured.

### DETAILED DESCRIPTION OF THE INVENTION

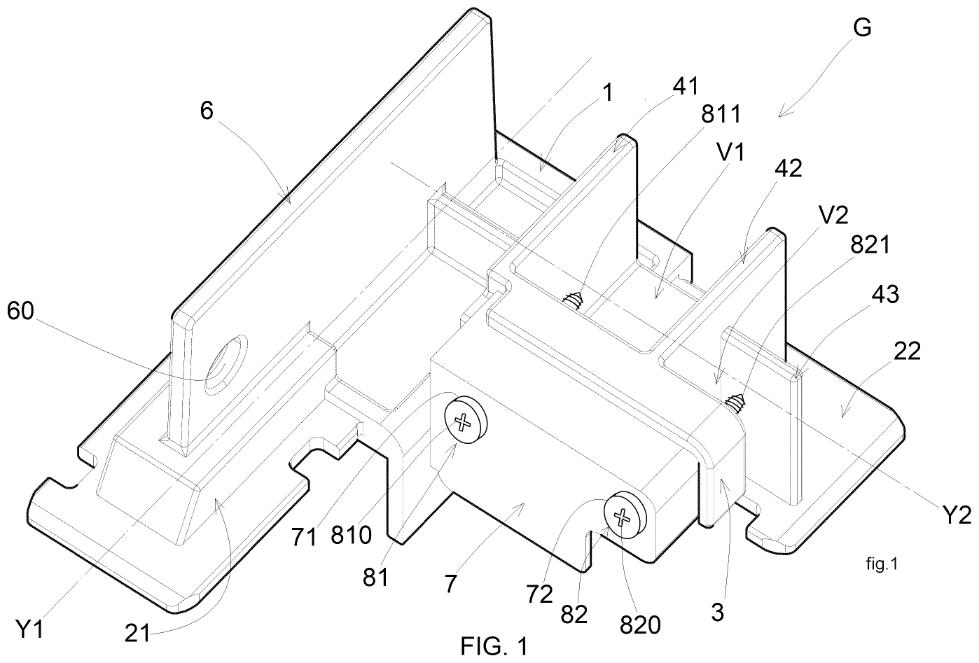

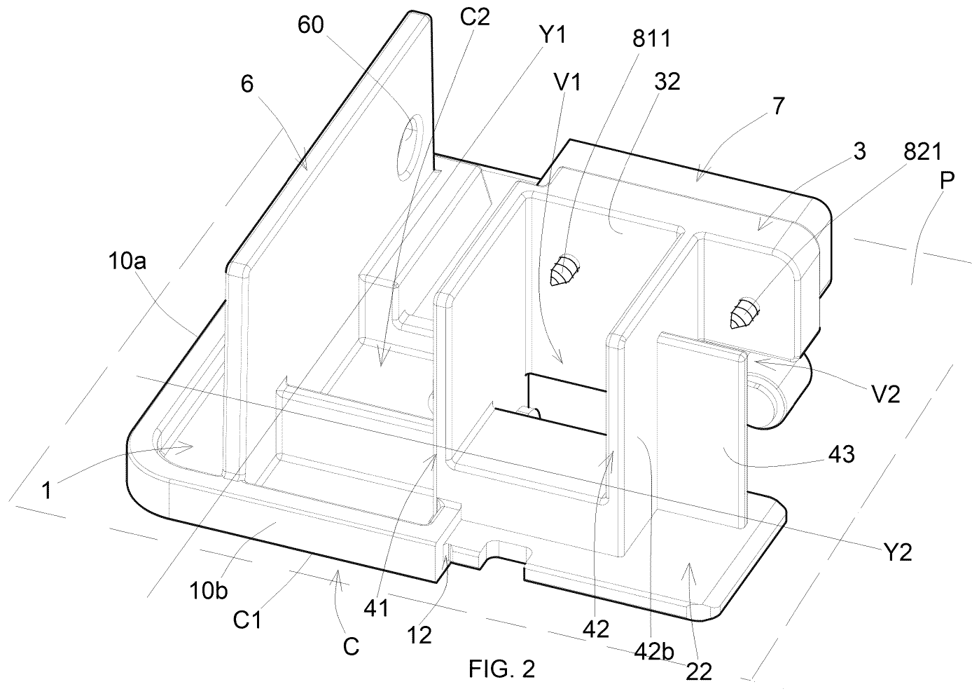

With reference to FIGS. 1-5, a corner assembly according to the invention is described, which is comprehensively indicated with the reference letter “G.”

Referring to FIGS. 1, 2, 3 and 4, the corner assembly (G) comprises a corner piece (100).

The corner piece (100) comprises a body (C) that is substantially planar and lies on a plane (P). The body (C) comprises a first face (C1) and a second face (C2). The body (C) comprises a central portion (1) that is quadrangular in shape and comprises two outer sides (10a, 10b) and two inner sides (11, 12).

Moreover, the body (C) comprises two inserts (21, 22) that protrude from the two inner sides (11, 12) of the central portion (1). The first insert (21) and the second insert (22) respectively extend along a first longitudinal axis (Y1) and a second longitudinal axis (Y2) orthogonal to each other and lying on the plane (P) of the body (C).

Each insert (21, 22) is suitable for being coupled with the ends of the sections of a fixed outer frame (T) of a trapdoor (B).

Specifically, the inserts (21, 22) are suitable for being inserted into the sections whereas the central portion (1) is suitable for abutting against the ends of the sections cut at 90°.

The corner piece (100) also comprises a support wall (3) rising orthogonally from the second face (C2) of the body (C) in correspondence with the second insert (22). The support wall (3) lies in a plane parallel to the second longitudinal axis (Y2). The support wall (3) comprises a front face (31) with a low-relief seat and a back face (32) opposite said front face (31).

Moreover, the support wall (3) comprises through holes (F1, F2), namely two through holes (F1, F2) that cross the support wall (3) from the front face (31) to the back face (32).

The corner assembly (G) further comprises a device (7), preferably a snap-fit locking device disposed on the front face (31) of the support wall (3) and supported by the support wall (3). The device (7) comprises holes (71, 72) aligned with the through holes (F1, F2) of the support wall (3).

The snap-fit locking device (7) will not be described in detail in the present patent application because it is well known to a technician of the field and is for example described in the above-mentioned patent application WO2022167230A1 in the name of the same applicant.

The snap-fit locking device (7) is suitable for cooperating with coupling means (N) provided on a door (E) of the trapdoor (B) for the purpose of elastically locking the door (E) of the trapdoor (B) in closing position. Also in this case the coupling means (N) are described in detail for example in WO2022167230A1.

Screws (81, 82), namely a first screw (81) and a second screw (82), are inserted through the holes (71, 72) of the device (7) and the through holes (F1, F2) of the support wall (3) to secure the device (7) to the support wall (3).

Each screw (81, 82) has a head (810, 820) abutting against the device (7) and a tip (811, 821) protruding from the back face (32) of the support wall (3).

The corner piece (100) also comprises at least one protective partition (41, 42, 43) connected to the body (C) behind the back face (32) of the support wall (3) in such a way to create at least one compartment (V1, V2) that accommodates the tips (811, 821) of the screws (81, 82) and prevents the accidental insertion of the user's fingers inside the compartment (V1, V2). This prevents the users from accidentally touching the tips of the screws disposed in the at least one compartment (V1, V2).

In the embodiment of the invention, the corner piece (100) comprises three protective partitions (41, 42, 43) defining two compartments (V1, V2), namely a first compartment (V1) that accommodates the tip (811) of the first screw (81) and a second compartment (V2) that accommodates the tip (821) of the second screw (82).

In the embodiment shown in the attached figures, the corner piece (100) comprises a first protective partition (41) and a second protective partition (42) disposed side-by-side and preferably parallel to each other, projecting posteriorly and orthogonally from the rear face (32) of the support wall (3). The first protective partition (41) and the second protective partition (42) are attached to the body (C) and support the support wall (3) in projecting position.

The first protective partition (41) and the second protective partition (42) define the first compartment (V1) and have inner faces (41a, 42a) facing each other and outer faces (41b, 42b) opposite to said inner faces (41a, 42a).

With reference to FIG. 4, between the first protective partition (41) and the second

protective partition (42) there is a distance (d1)—i.e. the distance between the facing inner faces (41a, 42a) of the two partitions (41, 42)-comprised between 1 cm and 2 cm.

Referring again to FIGS. 1, 2, 3 and 4, the corner piece (100) also comprises a third front protective partition (43) that is parallel to the support wall (3) and is arranged in front of the tip (821) of the second screw (82).

The front protective partition (43) is connected to a partition that projects posteriorly and orthogonally from the rear face (32) of the support wall (3).

With reference to FIGS. 1, 2, 3 and 4, the partition connected to the front protective partition (43) coincides with the second protective partition (42). In particular, the front protective partition (43) protrudes from the outer face (42b) of the second protective partition (42).

The second protective partition (42) and the front protective partition (43) define the second compartment (V2) that accommodates the tip (821) of the second screw (82). With reference to FIG. 4, between the front protective partition (43) and the back face (32) of the support wall (3) there is a distance (d3) comprised between 0.8 cm and 1.5 cm.

The corner piece (100) also comprises a partition (6) that protrudes from the body (C) in correspondence with the first insert (21). The partition (6) extends in length along a direction parallel to the first longitudinal axis (Y1) astride the first insert (21) and the central portion (1) of the corner piece (100). The partition (6) comprises a hole (60) suitable for operating as coupling hole for a spring catch or a hook connected to a chain or a rope attached to the door of the trapdoor (B).

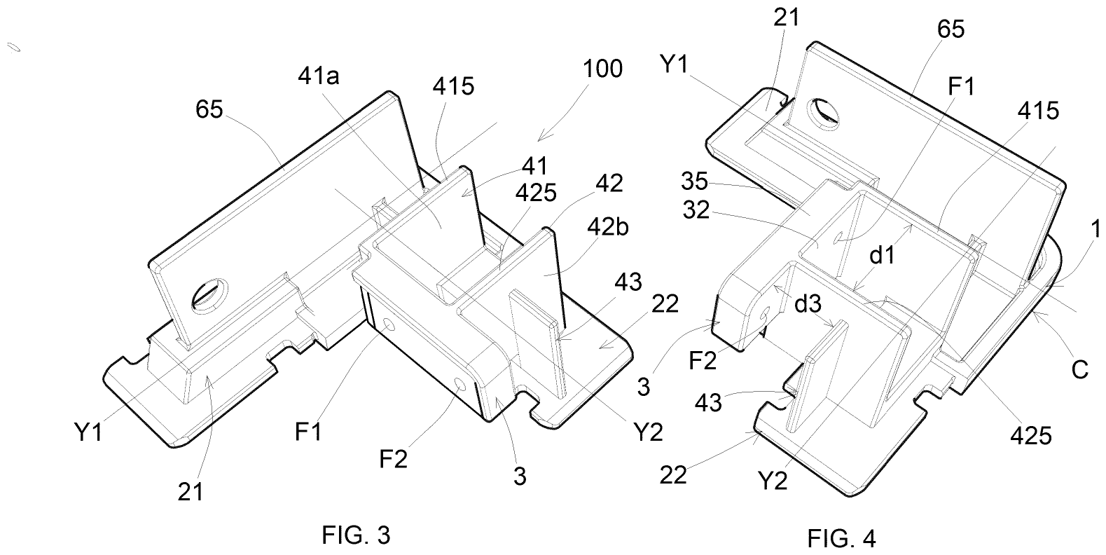

With reference to FIGS. 3 and 4, the support wall (3), the first protective partition (41), the second protective partition (42) and the partition (6) all have the same height in such a way as to have coplanar free end edges (35, 415, 425, 65) lying in a plane parallel to the body (C) of the corner piece (100).

Due to such a peculiarity, should the corner piece (100) be positioned on a support plane (J) with the end edges (35, 415, 425, 65) abutting on the support plane (J), said corner piece (100) will be arranged in a substantially vertical position with the body (C) in parallel direction to the support plane (J).

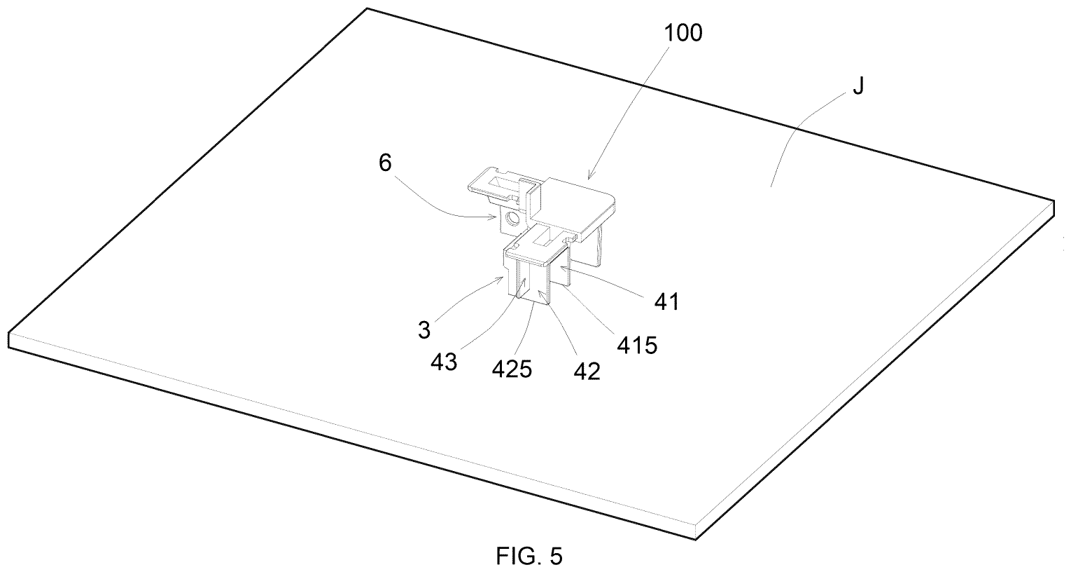

For illustrative purposes, the vertical position of the corner piece (100) is shown in FIG. 5. Such a vertical position significantly facilitates the picking up of the corner piece (100) by an automated robotic arm. In the preferred embodiment of the invention, the body (C), the support wall (3), the protective partitions (41, 42, 43) and the partition (6) of the corner piece (100) are machined in one piece.

Otherwise said, the corner piece (100) is monolithic and is preferably made of plastic material, die-cast aluminum or composite material, such as polyamide PA6 loaded with glass and/or carbon fiber, or polyarylamide (Kitan X).

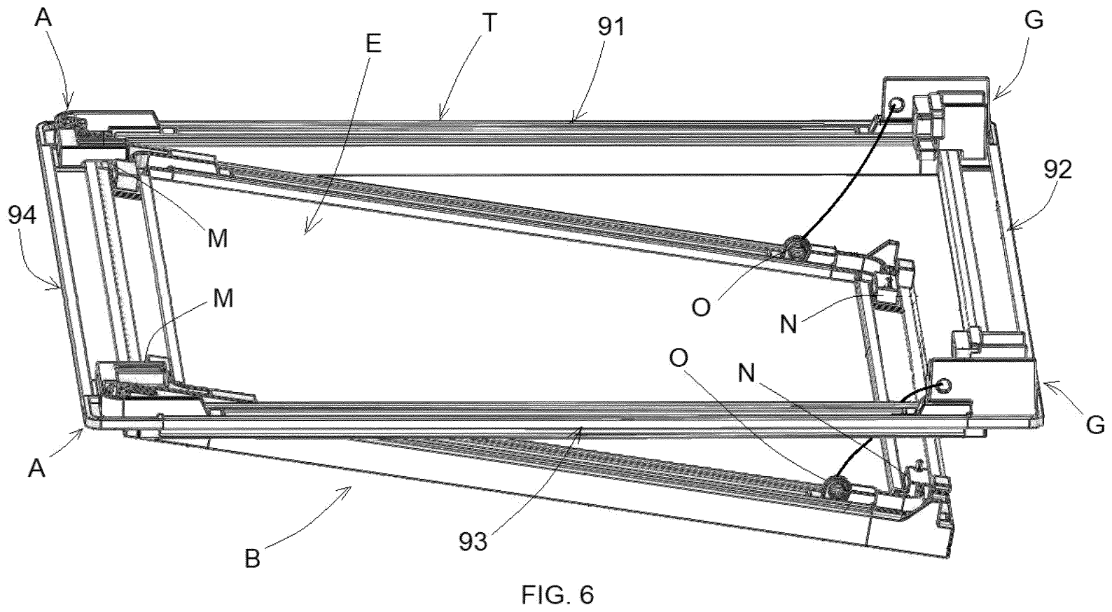

FIG. 6 shows a trapdoor (B) comprising a fixed frame (T) provided with corner assemblies (G) according to the invention.

Specifically, the trapdoor (B) shown in FIG. 6 comprises a fixed frame (T) defining a central opening and a door (E) disposed in the central opening and movably connected to the fixed frame (T) in such a way to be alternately disposed in opening position and in closing position.

In particular, the fixed frame (T) comprises:
four sections (91, 92, 93, 94) with ends cut at 90° disposed at right angles;
two corner assemblies (G) and two additional corner pieces (A).

Each one of said additional corner pieces (A) and of the corner pieces (100) of the corner assemblies (G) connects two adjacent profiles (91, 92, 93, 94) in a perpendicular arrangement.

Movable connection means (M) are provided between the door (E) and the two corner pieces (A) to let the door (E) oscillate between the opening and the closing position.

For illustrative purposes, the movable connection means (M) may be those described in the patent application WO2022167230A1.

The door (E) is provided with coupling means (N) suitable for cooperating with the snap-fit locking device (7) and two eyelets (O), each one of them being attached to a chain or a rope, which is attached in turn to the coupling hole (60) of one of the two partitions (6).

The door (E) can be a monolithic door or, as shown in FIG. 6, a door composed of a frame (comprising sections and corner pieces) and a panel supported by the frame. Also in this case, the door (E) can be made like the one described in the patent application WO2022167230A1.

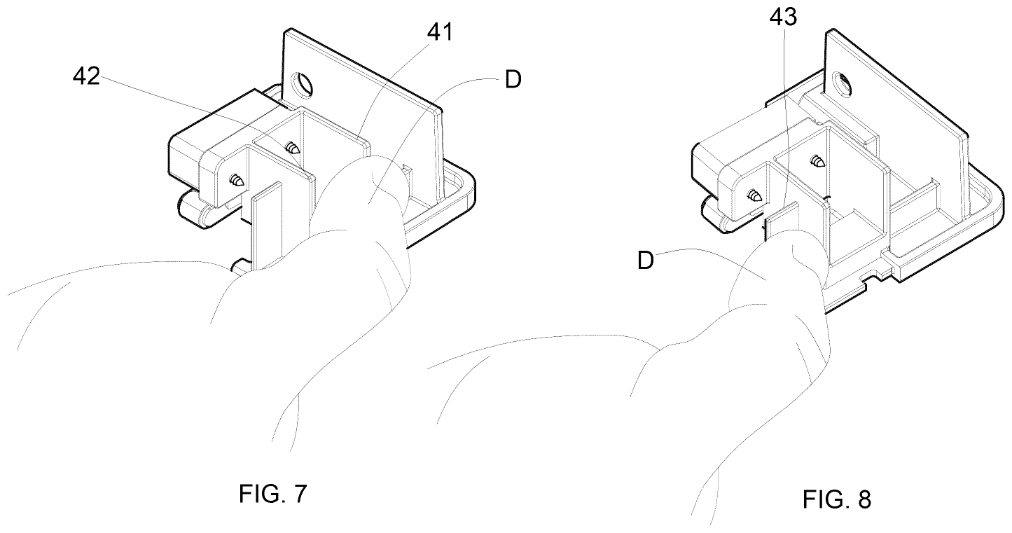

By way of example, FIGS. 7 and 8 show two ways in which the user can use the protective partitions (41, 42, 43) to grab the corner piece (100) when installing the trapdoor (B).

With reference to FIG. 7, a thumb (D) of a user who is pushing against the end edges of the first and of the second protective partitions (41, 42) is illustrated.

With reference to FIG. 8, a thumb (D) of a user who is pushing against the front protective partition (43) is illustrated.

As a result of the above description, it is now evident that the protective partitions (41, 42, 43) operate as safety means that prevent the user from accessing the compartments (V1, V2) where the tips of the screws are arranged.

Otherwise said, due to the provision of the protective partitions (41, 42, 43), the possibility that a user can accidentally touch the tips of the screws and get injured during the installation of the trapdoor is significantly reduced.

Numerous variations and modifications of detail may be made to the present embodiment of the invention, within the reach of a person skilled in the art, but still within the scope of the invention as expressed by the appended claims.

1. Corner assembly of an outer frame of a trapdoor, wherein said corner assembly comprises a corner piece comprising:
a body lying on a plane and having a first insert and a second insert respectively extending along a first longitudinal axis and a second longitudinal axis that are perpendicular to each other and suitable for being coupled with the sections of the outer frame of a trapdoor;
a support wall rising orthogonally from the body in correspondence with the second insert and in parallel position to the second longitudinal axis, said support wall comprises a front face and a rear face, said support wall comprises through holes;
wherein said corner assembly further comprises:
a device arranged on the front face of the support wall and supported by said support wall, said device comprises holes aligned with the through holes of the support wall (3);
crews inserted through the through holes of the support wall and the holes of the device to secure the device to the support wall, each screw having a tip protruding from the rear face of the support wall (3);
wherein the corner piece comprises at least one protective partition connected to the body behind the rear face of the support wall in such a way to create at least one compartment that accommodates the tips of the screws and prevents the user from accidentally inserting his/her fingers inside the at least one compartment.

2. The corner assembly of claim 1, comprising a first protective partition and a second protective partition arranged side-by-side that protrude posteriorly and orthogonally from the rear face of the support wall, wherein said first protective partition and said second protective partition have inner faces facing each other and outer faces opposite to said inner faces, wherein a distance comprised between 1 cm and 2 cm is provided between said first protective partition and said second protective partition.

3. The corner assembly of claim 1, comprising a front protective partition that is parallel to said support wall and is arranged in front of the tip of the second screw, wherein a distance comprised between 0.8 cm and 1.5 cm is provided between said front protective partition and said rear face of said support wall.

4. The corner assembly of claim 3, wherein said front protective partition is connected to a partition that protrudes posteriorly and orthogonally from the rear face of the support wall.

5. The corner assembly of claim 4, wherein said partition to which the front protective partition is connected coincides with the second protective partition, wherein said front protective partition protrudes from the outer face of the second protective partition.

6. The corner assembly of claim 2, wherein said support wall, said first protective partition and said second protective partition all have the same height in such a way to have coplanar free ending edges lying in a plane parallel to the plane whereon the body lies.

7. The corner assembly of claim 1, comprising a partition projecting from the body in correspondence with the first insert and extending along a direction parallel to the first longitudinal axis, wherein said partition has an attachment hole for a chain or a rope.

8. The corner assembly of claim 7, wherein the height of said partition is equal to the height of the support wall and of the protective partitions so as to have an ending edge coplanar with the ending edges of the protective partitions and of the support wall.

9. The corner assembly of claim 1, wherein said body of the corner piece comprises a central portion having a quadrangular shape and comprising two outer sides and two inner sides, wherein said two inserts of the body protrude from the two inner sides of the central portion of the body.

10. The corner assembly of claim 1, wherein said corner piece is monolithic.

11. Fixed frame of a trapdoor comprising:
four sections provided with ends cut at 90° and arranged at right angle; and
two corner assemblies according to claim 1, and two additional corner pieces, wherein each one of said additional corner pieces and of the corner pieces of the corner assemblies connects two adjacent profiles in a perpendicular arrangement.

12. Trapdoor comprising:
a fixed frame of claim 11; and
a door movably connected to the fixed frame.
